(19) United States
(12) Patent Application Publication
(10) Pub. No.: US 2026/0126139 A1
(43) Pub. Date: May 7, 2026

(54) ROTARY JOINT FOR HOSE REEL DEVICES

(71) Applicant: RAMEX S.R.L., Quattro Castella (RE) (IT)

(72) Inventor: Leonardo RUOZI, Quattro Castella (RE) (IT)

(21) Appl. No.: 19/380,635

(22) Filed: Nov. 5, 2025

(30) Foreign Application Priority Data
Nov. 6, 2024 (IT) 102024000024903

(51) Int. Cl. F16L 27/08; F16L 3/01

(52) U.S. Cl. CPC F16L 27/0845; F16L 3/012

(57) ABSTRACT

The rotary joint (1) for hose reel devices, comprises:
one rotor body (2) and one stator body (3) coaxially associated along a main axis (4) to define a male-female coupling and a duct (5) for the flow of a liquid product;
interconnection means (6) comprising at least one bearing element (6) placed between the rotor body (2) and the stator body (3) and adapted to enable the rotation of the rotor body (2) with respect to the stator body (3);
   wherein the rotor body (2), in use, can be locked together with the supporting body (7) of a hose reel device (8), the supporting body (7) and the rotor body (2) rotating locked together to enable the winding/unwinding of a hose around/from the supporting body (7);
   wherein the stator body (3), in use, is connectable to a delivery tube of the liquid product to be dispensed with the hose.

### TECHNICAL FIELD

The present invention relates to a rotary joint for hose reel devices.

### BACKGROUND ART

In various manufacturing and/or working sectors, hoses made of a flexible material are widely used to dispense liquids, such as water or fuel.

In order to facilitate the use, transport, and storage of the aforementioned hoses, hose reel devices are commonly used.

Hose reel devices generally comprise a base frame, which can be connected to a surface, and a supporting body, to which one end of a hose is attached and which supporting body is made to rotate with respect to the base frame so as to wind or unwind the hose itself.

Hose reel devices of known type comprise a rotary joint associated with the supporting body and defining a flowing duct for a liquid.

The flowing duct can be connected on one side to the hose that can be wound around the supporting body and on the other side to a delivery tube for the liquid to be dispensed.

This rotary joint allows the supporting body to rotate with respect to the delivery tube, which in fact remains stationary during the winding/unwinding of the hose.

The rotary joints which are generally mounted on hose reel devices comprise:
a rotor body that is connected to the supporting body and rotates locked together with the latter;
a stator body that is connected to the liquid delivery tube and that is coupled to the rotor body to form a male-female coupling;
interconnection means adapted to enable the rotation of the rotor body with respect to the stator body.

The interconnection means of the rotary joints known to date comprise a plurality of balls positioned between the rotor body and the stator body, which allow these to rotate with respect to each other.

Appropriately, the rotor body and the stator body have a substantially tubular conformation to define the flowing duct for the liquid to be dispensed.

The stator body and the rotor body bound at least one substantially ring-shaped housing seat, wherein the balls are positioned so as to define a crown of balls arranged between the rotor body and the stator body.

Specifically, respective grooves are made on the rotor body and on the stator body which, when the rotor body and the stator body are coupled, define the housing seat for the balls.

However, this type of rotary joint for hose reel devices has some drawbacks related to the presence of the crown of balls and of the grooves on the rotor body and on the stator body, which result in couplings with play between the rotor body and the stator body.

In particular, the creation of grooves on the rotor body and on the stator body requires complex mechanical machining operations involving wide machining tolerances, which result in the aforementioned coupling with play.

The presence of play between the rotor body and the stator body can cause the latter to tilt with respect to the axis of mutual alignment during use.

This tilting causes uneven friction between the parts in contact, during use, and, consequently, uneven wear of the same, while reducing the smooth rotation of the rotor body with respect to the stator body.

Furthermore, the loss of coaxiality between the rotor body and the stator body results in a lower seal of the working liquid flowing duct, which consequently limits the maximum working pressure that can be used, thus affecting the performance of the rotary joint.

Furthermore, in order to fit the balls into the housing seat, it is necessary to make one or more through openings on the outermost one of either the rotor body or the stator body.

The presence of these through openings not only complicates the manufacture of the rotary joint but also promotes the accumulation of dirt on the outer surface of the rotary joint.

Furthermore, to allow the rotor body to rotate with respect to the stator body, the balls must be lubricated and, consequently, a channel must be created for the introduction of the lubricant and an additional seal must be provided to limit its leakage.

In addition, in ball rotary joints, the inner part of the rotary joint and the ball containment seats are made of galvanized metallic material, and the balls are made of hardened metallic material, such as stainless steel.

As the balls slide, they quickly wear down the inner surface of the rotary joints at the relevant containment seats.

This aspect inevitably leads to misalignment between the rotor body and the stator body in known types of ball rotary joints.

In the light of these considerations, it is clear that the rotary joints for hose reel devices of known type are complex to manufacture, require frequent and complicated maintenance, and are characterized by reduced performance that limits their fields of application.

### DESCRIPTION OF THE INVENTION

The main aim of the present invention is to devise a rotary joint for hose reel devices that allows reducing the couplings with play between the rotor body and the stator body.

Within the scope of this aim, the present invention aims to devise a rotary joint for hose reel devices that limits the flexing of the rotor body and/or of the stator body with respect to the axis of mutual coupling, maintaining them substantially coaxial, during use.

Furthermore, another object of the present invention is to devise a rotary joint for hose reel devices that allows improving the seal of the inner duct, thus allowing the liquid product to be dispensed at a higher pressure than is possible with the prior art.

Again, another object of the present invention is to devise a rotary joint for hose reel devices that can be made using simpler and faster machining procedures than is currently the case and that requires simple maintenance operations, to be carried out less frequently than is the case with the prior art.

Another object of the present invention is to devise a rotary joint for hose reel devices that allows the aforementioned drawbacks of the prior art to be overcome within the scope of a simple, rational, easy and effective to use solution that is also affordable.

The aforementioned objects are achieved by the present rotary joint for hose reel devices having the characteristics of claim 1.

The aforementioned objects are further achieved by the hose reel device having the characteristics of claim 13.

### BRIEF DESCRIPTION OF THE DRAWINGS

Other characteristics and advantages of the present invention will become more apparent from the description of a preferred, but not exclusive, embodiment of a rotary joint for hose reel devices, illustrated by way of an indicative, yet non-limiting example in the accompanying drawings, in which:

FIG. 1 is an axonometric view of a hose reel device comprising a rotary joint according to the invention;

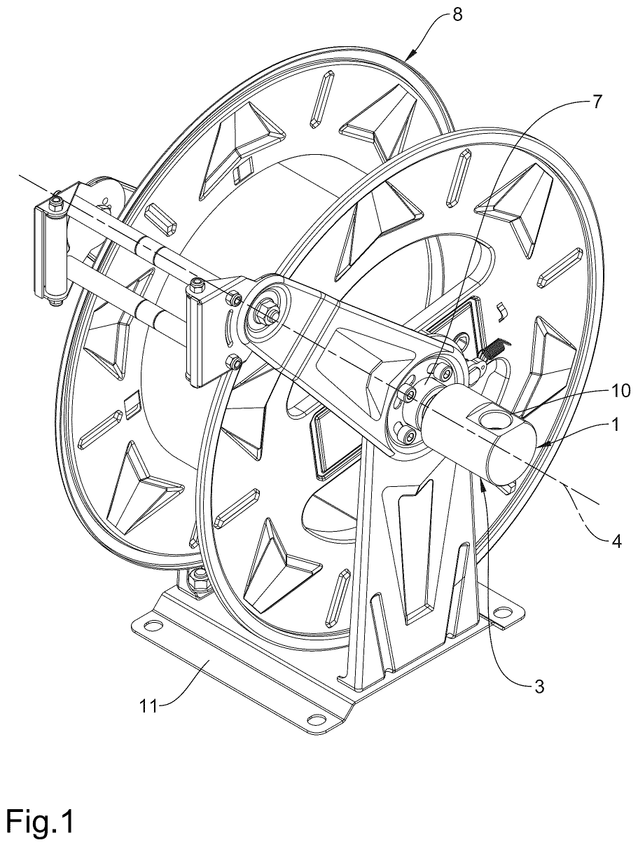

FIG. 2 is an axonometric view of a rotary joint according to the invention;

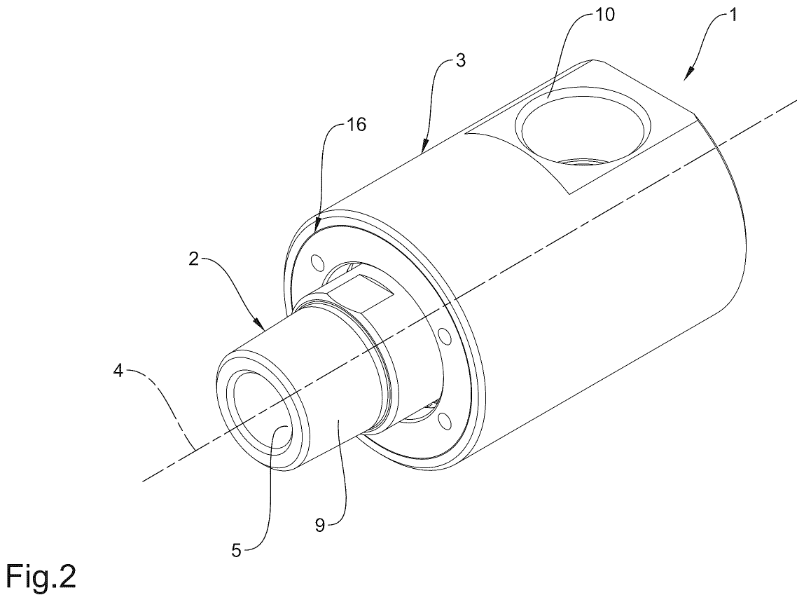

FIG. 3 is an exploded view of the rotary joint of FIG. 2;

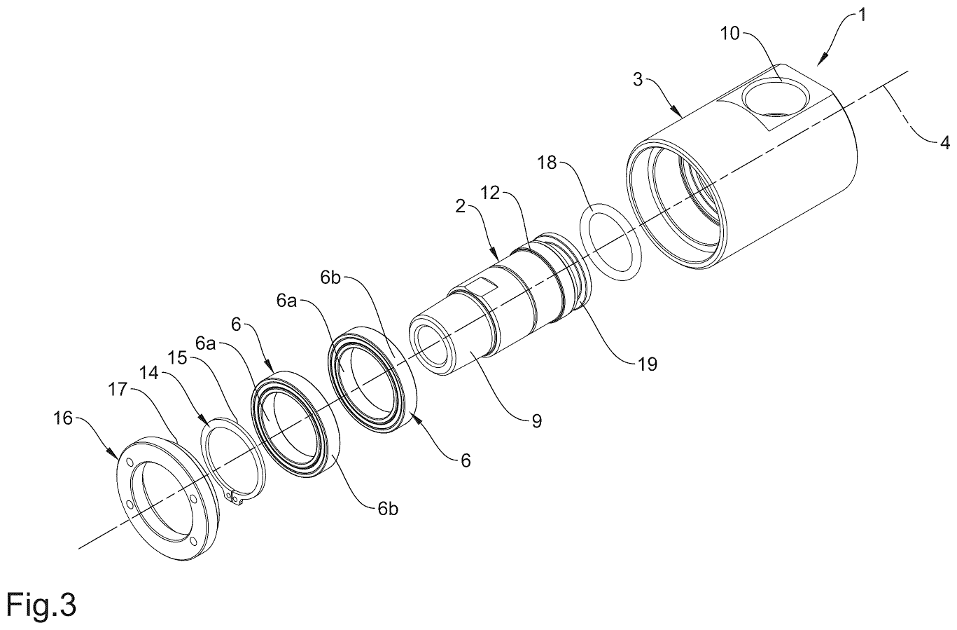

FIG. 4 is a cross-sectional view of the rotary joint of FIG. 2.

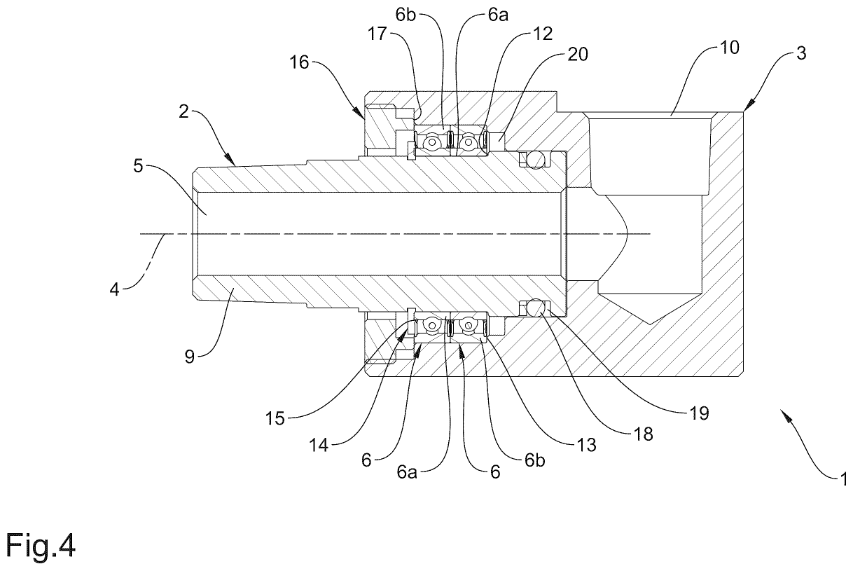

### EMBODIMENTS OF THE INVENTION

With particular reference to these figures, reference numeral 1 globally denotes a rotary joint for hose reel devices.

The rotary joint 1 comprises:
at least one rotor body 2 and at least one stator body 3 having a substantially tubular conformation and coaxially associated along a main axis 4 to define a male-female coupling and a duct 5 for the flow of a liquid product;
interconnection means 6 placed between the rotor body 2 and the stator body 3 and adapted to enable the rotation of the rotor body 2 around the main axis 4 with respect to the stator body 3.

The rotor body 2, in use, can be locked together with the supporting body 7 of a hose reel device 8.

The supporting body 7 and the rotor body 2 rotate locked together around the main axis 4 so as to allow the winding/unwinding of a hose around/from the supporting body 7.

The stator body 3, in use, is connectable in a fluid-operated manner to a delivery tube of the liquid product to be dispensed with the hose.

Conveniently, the rotor body 2 is provided with a coupling portion 9 that can be coupled to the supporting body 7.

Advantageously, the stator body 3 comprises one opening 10 to which the delivery tube of the liquid product can be connected.

The opening 10 is connected to the duct 5 in a fluid-operated manner.

The hose reel device 8, provided with the rotary joint 1, comprises a base frame 11 which, in use, is connected to a supporting surface which may e.g. coincide with the floor of a building or with a vertical wall.

When using the hose reel device 8, one end of the hose is connected to the supporting body 7 and the latter is made to rotate, with respect to the base frame 11, in one way or the opposite way, depending on whether the hose is to be wound around or unwound from the supporting body 7.

The supporting body 7 has a substantially tubular conformation and internally defines a flowing channel of the liquid product that can be connected on one side to the liquid product delivery tube and on the other side to the hose adapted to dispense the liquid product itself.

The rotary joint 1 is placed between the supporting body 7 and the liquid product delivery tube and is adapted to release the supporting body 7, during the rotation thereof, from the delivery tube, which in fact remains stationary.

In detail, the coupling portion 9 is connected to the flowing channel defined by the supporting body 7 and the opening 10 is connected to the delivery tube.

With particular reference to the specific embodiment shown in the figures, the rotor body 2 is male-shaped and the stator body 3 is female-shaped.

In other words, the rotor body 2 is partly inserted within the stator body 3.

However, this particular design choice should not be seen as limiting but only as an example of a possible embodiment of the rotary joint 1.

In fact, alternative embodiments of the rotary joint 1 cannot be ruled out, wherein the rotor body 2 is female-shaped and the stator body 3 is male-shaped.

According to the invention, the interconnection means 6 comprise at least one bearing element 6 placed between the rotor body 2 and the stator body 3.

Usefully, the interconnection means 6 comprise at least two bearing elements 6 arranged in succession with each other along the main axis 4.

Advantageously, the bearing elements 6 are of the radial type and the inner rings 6a and the outer rings 6b of each of the bearing elements 6 are arranged in contact with the inner rings 6a and with the outer rings 6b of the adjacent bearing element 6, respectively.

In other words, the bearing elements 6 are positioned adjacent to each other to define a substantially compact structure developed along the main axis 4.

The fact of providing at least one bearing element 6, preferably at least two bearing elements 6, allows the axial connection between the rotor body 2 and the stator body 3 to be maintained, thus making the rotation of the rotor body 2 around the main axis 4 smoother.

In detail, the presence of the bearing elements 6 limits the presence of couplings with play between the rotor body 2 and the stator body 3 and reduces the friction between them, limiting the wear thereof.

Thanks to the presence of the bearing elements 6, it is possible to significantly limit the wear of the rotary joint 1, resulting in an extension of the life cycle of the rotary joint 1 itself compared to the solutions of known type in which balls are provided.

Preferably, the rotor body 2 and the stator body 3 are both made of 303 or 316 stainless steel.

Usefully, the outer surface of the one of either the rotor body 2 or the stator body 3 positioned externally to the other is substantially seamless.

With reference to the particular embodiment shown in the figures, the outer surface of the stator body 3 is substantially seamless, i.e., substantially smooth.

This feature allows reducing the accumulation of dirt on the outer surface of the one of either the rotor body 2 or the stator body 3 which is positioned externally to the other.

This particular technical expedient is made possible by the fact that, according to the invention, bearing elements 6 are used instead of balls, as is the case in the prior art.

In fact, the bearing elements 6 are placed between the stator body 3 and the rotor body 2 before they are coupled, unlike what happens when ball rotary joints are used.

Usefully, the one of either the rotor body 2 or the stator body 3 positioned internally of the other defines a first axial abutment surface 12 on which the inner ring 6a of one of the bearing elements 6 is positioned in abutment.

With reference to the particular embodiment shown in the figures, the first abutment surface 12 is formed on the rotor body 2.

Advantageously, the one of either the rotor body 2 or the stator body 3 positioned externally to the other defines a second axial abutment surface 13 on which the outer ring 6b of one of the bearing elements 6 is positioned in abutment.

With reference to the particular embodiment shown in the figures, the second abutment surface 13 is formed on the stator body 3.

The first abutment surface 12 and the second abutment surface 13 are coplanar with each other.

In detail, the first abutment surface 12 and the second abutment surface 13 are made on the same laying plane, which is substantially orthogonal to the main axis 4.

Conveniently, the first abutment surface 12 and the second abutment surface 13 are adapted to prevent the axial displacement of the bearing elements 6 along the main axis 4 and along a first way.

The first abutment surface 12 and the second abutment surface 13 actually block the bearing element 6 with which they are associated and, consequently, the bearing element 6 adjacent to the latter, along a first way of movement defined along the main axis 4.

Advantageously, the rotary joint 1 comprises at least one annular body 14 associated with the one of either the rotor body 2 or the stator body 3 positioned internally to the other, wherein the annular body 14 defines a first axial holding surface 15 on which the inner ring 6a of one of the bearing elements 6 is positioned in abutment.

In this way, it is possible to axially block the rotor body 2 with respect to the stator body 3.

The first holding surface 15 is arranged on the opposite side of the first abutment surface 12 with respect to the bearing elements 6 so as to bound a containment seat for containing the bearing elements themselves.

Preferably, the annular body 14 is of the Seeger type.

With particular reference to the specific embodiment shown in the figures, the annular body 14 is associated with the rotor body 2.

Usefully, the rotary joint 1 comprises at least one ring nut element 16 associated with one of either the rotor body 2 or the stator body 3 in a removable manner and defining a second axial holding surface 17, upon which the outer ring 6b of one of the bearing elements 6 is positioned in abutment.

The second holding surface 17 is arranged on the opposite side of the second abutment surface 13 with respect to the bearing elements 6.

Advantageously, the first holding surface 15 and the second holding surface 17 are coplanar with each other.

In detail, the first holding surface 15 and the second holding surface 17 are made on the same laying plane, which is substantially orthogonal to the main axis 4.

Usefully, the first holding surface 15 and the second holding surface 17 are adapted to prevent the bearing elements 6 from axially displacing along the main axis 4 along a second way opposite the first way.

The first holding surface 15 and the second holding surface 17 actually block the bearing element 6 with which they are associated and, consequently, the bearing element 6 adjacent to the latter, along a second way of sliding defined along the main axis 4.

The synergistic combination of the abutment surfaces 12, 13 with the holding surfaces 15, 17 allows the sliding of the bearing elements 6 along the main axis 4 to be blocked, which bearing elements are actually maintained substantially blocked in a fixed position between the rotor body 2 and the stator body 3.

Preferably, the ring nut element 16 is internally screwable to the one of either the rotor body 2 or the stator body 3 which is arranged externally.

With reference to the particular embodiment shown in the figures, the ring nut element 16 is screwable onto the stator body 3.

Advantageously, the rotary joint 1 comprises at least one sealing element 18 placed between either the rotor body 2 or the stator body 3 and adapted to prevent the liquid product from flowing out of the duct 5.

Usefully, the one of either the rotor body 2 or the stator body 3 positioned within the other defines, at the relative outer surface, at least one housing compartment 19 of the sealing element 18.

The housing compartment 19 is of the type of a groove formed on the outer surface of the innermost one of either the rotor body 2 or the stator body 3.

With reference to the particular embodiment shown in the figures, the housing compartment 19 is made on the outer surface of the rotor body 2.

Conveniently, between the rotor body 2 and the stator body 3 at least one work chamber 20 is defined which is adapted to allow the inner ring 6a to roll.

Preferably, the work chamber 20 is placed between the bearing elements 6 and the housing compartment 19.

According to a further aspect, the present invention relates to a hose reel device 8 comprising:
at least one base frame 11 connectable to a supporting surface;
at least one supporting body 7 of a hose, associated with the base frame 11 and rotatable with respect to the latter to allow the hose to be wound/unwound
around/from the supporting body 7;
at least one rotary joint 1 according to one or more of the embodiments described above;
   wherein the supporting body 7 is locked together in rotation with the rotor body 2 around the main axis 4, the main axis 4 being substantially coincident with the axis of rotation of the supporting body 7;
   wherein the stator body 3 is associated with the delivery tube of the liquid product to be dispensed with the hose.

The description of the hose reel device 8 according to the invention and of the rotary joint 1 with which it is provided can be found in the description given above.

It has in practice been ascertained that the described invention achieves the intended objects and, in particular, the fact should be emphasized that the rotary joint according to the invention, thanks to the presence of at least one bearing element, makes it possible to limit the presence of couplings with play between the rotor body and the stator body.

In particular, the use of bearing elements to achieve the relevant rotary movement between the rotor body and the stator body makes it possible to reduce and simplify mechanical machining operations and, therefore, to obtain tighter machining tolerances.

This allows limiting the flexing of the rotor body and/or of the stator body with respect to the axis of mutual coupling and maintaining axial alignment during use. The use of bearing elements therefore allows reducing unwanted wear, thus extending the life of the components used.

The ability to maintain axial alignment between the rotor body and the stator body also improves the seal of the duct, thus allowing the liquid product to be sent inside the duct at a higher pressure than is currently the case, thus improving the overall performance of the joint.

Furthermore, the rotary joint according to the invention can be manufactured using simpler and faster machining procedures than is currently the case and requires simpler and less frequent maintenance operations than those required by the rotary joints for hose reel devices of known type.

1. Rotary joint (1) for hose reel devices, comprising:
at least one rotor body (2) and at least one stator body (3) having a substantially tubular conformation and coaxially associated along a main axis (4) to define a male-female coupling and a duct (5) for the flow of a liquid product;
interconnection means (6) placed between said rotor body (2) and said stator body (3) and adapted to enable the rotation of said rotor body (2) around said main axis (4) with respect to said stator body (3);
wherein said rotor body (2), in use, can be locked together with the supporting body (7) of a hose reel device (8), said supporting body (7) and said rotor body (2) rotating locked together around said main axis (4) to enable the winding/unwinding of a hose around/from the supporting body (7);
wherein said stator body (3), in use, is connectable in a fluid-operated manner to a delivery tube of the liquid product to be dispensed with the hose;
characterized by the fact that said interconnection means (6) comprise at least one bearing element (6) placed between said rotor body (2) and said stator body (3).

2. Rotary joint (1) according to claim 1, characterized by the fact that said interconnection means (6) comprise at least two of said bearing elements (6) arranged in succession with each other along said main axis (4).

3. Rotary joint (1) according to claim 1, characterized by the fact that said bearing elements (6) are of the radial type and by the fact that the inner rings (6a) and the outer rings (6b) of each of said bearing elements (6) are arranged in contact with the inner rings (6a) and with the outer rings (6b) of said adjacent bearing element (6), respectively.

4. Rotary joint (1) according to claim 1, characterized by the fact that the outer surface of the one of either said rotor body (2) or said stator body (3) positioned externally to the other is substantially seamless.

5. Rotary joint (1) according to claim 1, characterized by the fact that the one of either said rotor body (2) or said stator body (3) positioned internally of the other defines a first axial abutment surface (12) on which the inner ring (6a) of one of said bearing elements (6) is positioned in abutment.

6. Rotary joint (1) according to claim 1, characterized by the fact that the one of either said rotor body (2) or said stator body (3) positioned externally to the other defines a second axial abutment surface (13) on which the outer ring (6b) of one of said bearing elements (6) is positioned in abutment, said first abutment surface (12) and said second abutment surface (13) being coplanar with each other.

7. Rotary joint (1) according to claim 1, characterized by the fact that it comprises at least one annular body (14) associated with the one of either said rotor body (2) or said stator body (3) positioned internally to the other, wherein said annular body (14) defines a first axial holding surface (15) on which the inner ring (6a) of one of said bearing elements (6) is positioned in abutment, said first holding surface (15) being arranged on the opposite side of said first abutment surface (12) with respect to said bearing elements (6) so as to bound a containment seat of the bearing elements themselves.

8. Rotary joint (1) according to claim 1, characterized by the fact that it comprises at least one ring nut element (16) associated with one of either said rotor body (2) or said stator body (3) in a removable manner and defining a second axial bearing surface (17), upon which the outer ring (6b) of one of said bearing elements (6) is positioned in abutment, said second holding surface (17) being arranged on the opposite side of said second abutment surface (13) from said bearing elements (6).

9. Rotary joint (1) according to claim 1, characterized by the fact that said ring nut element (16) is internally screwable to the one of either said rotor body (2) or said stator body (3) which is arranged externally.

10. Rotary joint (1) according to claim 1, characterized by the fact that it comprises at least one sealing element (18) placed between either said rotor body (2) or said stator body (3) adapted to prevent the liquid product from flowing out of said duct (5) and by the fact that the one of either said rotor body (2) or said stator body (3) positioned within the other defines, at the relevant outer surface, at least one housing compartment (19) of said sealing element (18).

11. Rotary joint (1) according to claim 1, characterized by the fact that between said rotor body (2) and said stator body (3) is defined at least one work chamber (20) adapted to allow said inner ring (6a) to roll.

12. Rotary joint (1) according to claim 1, characterized by the fact that said work chamber (20) is placed between said bearing elements (6) and said housing compartment (19).

13. Hose reel device (8), comprising:
at least one base frame (11) connectable to a supporting surface;
at least one supporting body (7) of a hose, associated with said base frame (11) and rotatable with respect to the latter to allow winding/unwinding the hose around/from said supporting body (7);
at least one rotary joint (1) according to claim 1;
wherein said supporting body (7) is locked together in rotation with said rotor body (2) around said main axis (4), said main axis (4) being substantially coincident with the axis of rotation of said supporting body (7);
wherein said stator body (3) is associated with the delivery tube of the liquid product to be dispensed with the hose.
